(19) United States
(12) Patent Application Publication
(10) Pub. No.: US 2012/0194957 A1
(43) Pub. Date: Aug. 2, 2012

(54) Anovel Protection Method Of Direct Currrent Converter Valve Thyristor In Discontinuous Current Mode

(76) Inventors: Xiaoguang Wei, Beijing (CN); Huafeng Wang, Beijing (CN); Longlong Chen, Beijing (CN)

(21) Appl. No.: 13/255,500

(22) PCT Filed: Jun. 16, 2011
(86) PCT No.: PCT/CN2011/001003

§ 371 Date: Sep. 8, 2011

(30) Foreign Application Priority Data
Sep. 20, 2010 (CN) 201010288383.9

(51) Int. Cl. H02H 9/04

(52) U.S. Cl. 361/91.8

(57) ABSTRACT

The present provided a novel protection method of direct current converter valve thyristor in discontinuous current mode. In normal operation, the thyristor of converter valve will be triggered normally when thyristor anode and cathode voltage is positive, and thyristor electronics (TE) send pulse. If the discontinuous current happens, the current will over zero and the thyristor will cut off. After that if the forward voltage appears again, the voltage will be too great, more than the thyristor voltage capability. If the thyristor is not triggered immediately, the thyristor will be damaged probably. To ensure converter valve work normally in discontinuous current mode of the direct current transmission system, TE design has automatic re-trigger function to protect thyristor in discontinuous current mode; in triggering interval when forward voltage is up to +100V the thyristor will be re-triggered to ensure thyristor and system work safely and reliably.

### FIELD OF THE INVENTION

The present invention relates to electric device field, and relates particularly to a novel protection method of direct current converter valve thyristor in discontinuous current mode.

### BACKGROUND OF THE INVENTION

At present, there is no similar technology and invention at home and abroad. The converter valve is a very important primary equipment in direct current power transmission. In discontinuous current mode, if the current is over zero point, the thyristor will shut down naturally. It is due to thyristor's property. If forward over voltage is given after shut down, the thyristor will be damaged probably because thyristor electronics TE will not send trigger pulse. To ensure normal operation of thyristor in discontinuous current mode, TE designs automatic trigger function. When forward voltage is up to +100V, the thyristor will be triggered automatically in triggering interval. This ensures thyristor and system safe working. The thyristor usually is foreign equipment in traditional direct current power transmission project. The TE is also foreign. Therefore, there is no more thorough research and discussion about triggering thyristor in discontinuous current mode. Under this background, this invention researched the triggering thyristor basic principle in discontinuous current mode deeply. A detection window was set in TE to detect forward voltage, and trigger thyristor. It has very great innovation and feasibility.

The invention patent CN200720173252 titled by direct current converter valve low voltage operation test equipment said that cut off the low voltage and large current loop, turn the back-to-back high-voltage small current loop to discontinuous current mode, the current intermittent test can be finished. The invention provided a method of converter valve discontinuous current test, but didn't provide protection method of converter valve in discontinuous current mode. At present, there is no similar technology invention. This invention provided a method to protect converter valve in discontinuous mode, which is novel, simple and easy to realize.

### SUMMARY OF THE INVENTION

In normal operation, the thyristor of converter valve will be triggered normally when thyristor anode and cathode voltage is positive, and thyristor electronics (TE) send pulse. If the discontinuous current happens, the current will over zero, and the thyristor will cut off. After that if the forward voltage appears again, the voltage will be too great, more than the thyristor voltage capability. If the thyristor is not triggered immediately, the thyristor will be damaged probably. Preferred embodiments of the present invention seek to overcome above disadvantages of the prior design and provide a novel protection method of direct current converter valve thyristor in discontinuous current mode, this method includes: to ensure converter valve work normally in discontinuous current mode of the direct current transmission system, TE design has automatic re-trigger function to protect thyristor in discontinuous current mode; in triggering interval when forward voltage is up to +100V the thyristor will be re-triggered to ensure thyristor and system work safely and reliably.

This present invention provided a novel protection method of direct current converter valve thyristor in discontinuous current mode is characterized that thyristor electron plate TE designs automatic re-trigger function to ensure converter normal work in discontinuous current mode; When forward voltage is up to +100V, the thyristor will be re-triggered automatically in triggering interval, which ensures thyristor and system safe working; if discontinuous current happens, the thyristor will cut off because of over zero current, at that time thyristor is not in triggering interval yet; to protect thyristor from over voltage, the voltage triggering interval is set up; in this interval if test voltage peak is greater than discontinuous current setting value, the thyristor will be re-triggered.

wherein thyristor electron plate TE realizes automatic re-trigger function by electronic circuit; said electronic circuit is that thyristor voltage Uth links with a 99 k resistor and a 1 k resistor in series afford the voltage in 1:100 proportion; the compared threshold voltage is afford by voltage divider circuit 4 k resistor and 1 k resistor in series, and the threshold voltage is 1 V; when thyristor voltage Uth is greater than 100V, comparison circuit will output higher level, and then carry on logic “and” operation with triggering interval; in triggering interval and the thyristor voltage is greater 100V, the re-trigger pulse will be output, and trigger the thyristor to protect the thyristor.

wherein said trigger interval is designed according to signal triggered by the upper valve base electronics VBE which can build the thyristor triggering interval; valve base electronics VBE send double and single pulse to TE, time between double and single pulse is the width of triggering interval, beginning from double pulse complete to the single pulse complete.

Wherein said discontinuous current protection value can be set according to the practice operational project and thyristor, change the resistors partial voltage ratio in the test circuit, which can change the threshold of the comparison circuit to change the discontinuous current protection value.

The beneficial effect of this invention is described as below: the protection method provided this invention is novel, simple and easy to realize. This invention breaks the technology monopoly by foreign company, begins self-develop course on the thyristor reverse recovery protection circuit.

### BRIEF DESCRIPTION OF THE DRAWINGS

Currently preferred embodiments of the invention will now be described with reference to the following attached drawings in which:

FIG. 1 is schematic diagram of thyristor re-trigger;

FIG. 2 is waveform graph of triggering interval and voltage.

### DETAILED DESCRIPTION OF EMBODIMENTS

The detail of the embodiments is described as below incorporated with the figures by way of cross-reference.

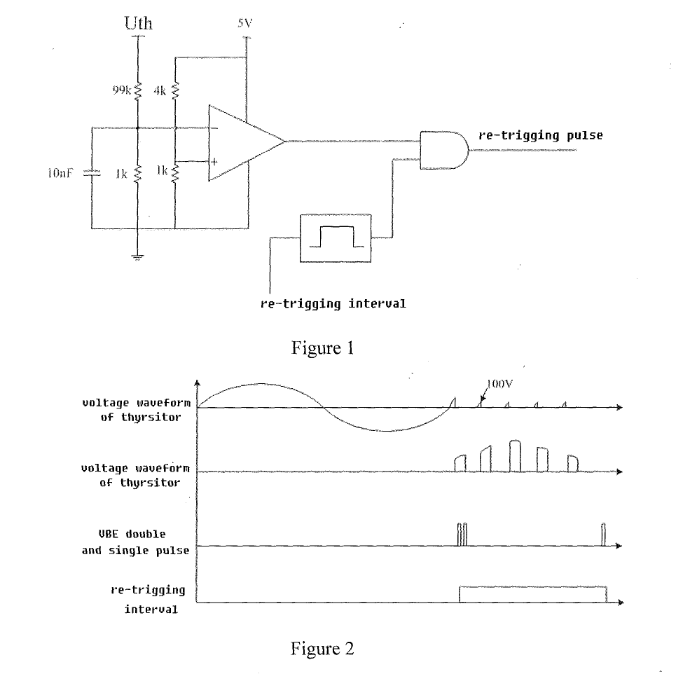

The invention disclosed a novel thyristor discontinuous current re-trigger method. If discontinuous current happens during working, the thyristor will cut off due to over zero current. At the time thyristor is not in triggering interval yet, so thyristor voltage triggering interval must be built to protect thyristor from over voltage damage. In this interval, test voltage peak value, if it greater than discontinuous current protection, re-trigger the thyristor to protect thyristor. Its working principle is shown as FIG. 1. in this figure, a 99 k resistor and a 1 k resistor in series constitute the thyristor voltage divider circuit. The 1 k resistor connects with a 10 nF capacitor in parallel to eliminate interference. The divided voltage signal is input from 1 K resistor, the divided voltage ratio is 100:1. it is that 100V voltage will produce 1V voltage signal. A 4 k resistor and a 1 k resistor in series constitute threshold comparison circuit, and the threshold voltage is 1V.

Firstly, the threshold voltage comparison circuit produces 1V threshold voltage. Testing thyristor anode and cathode voltage Uth, if it greater than 100V, the reverse end voltage input the comparison circuit is greater than 1V after voltage divider circuit. And comparison circuit will output high level, the Uth test will be completed through comparison circuit.

Secondly, as FIG. 2 shown, when TE receives double pulse and single pulse, the re-triggering interval will appear. The re-triggering interval begins from the second rising edge of double pulse to the falling edge of the single pulse. The pulse width of the triggering interval is the time between double and single pulse.

Thirdly, as FIG. 1 shown, when testing Uth voltage is greater than 100V, the comparison circuit will output high level, and this time is in the re-triggering interval. After the logic and calculation, the re-triggering pulse comes out. It realizes thyristor anode and cathode voltage test in the interval, if the voltage is greater than 100V re-trigger the thyristor to protect it from high voltage damage.

According to above three descriptions, it is concluded that the invention protection method of thyristor in discontinuous current mode can is effectively. The re-triggering voltage waveform is shown in FIG. 2. In re-triggering interval, when voltage is greater than 100V, thyristor will be re-triggered immediately, voltage reduce to zero, thyristor circuit produce current.

At last, the detail embodiment is one example of the invention but not the only one, so the person in this field must be understand that all the alternatives and other equal and/or similar examples are all within the range of the invention and they are all consistent with the spirits of this invention, are all protected by our claims.

1. A novel protection method of direct current converter valve thyristor in discontinuous current mode is characterized that thyristor electron plate TE designs automatic re-trigger function to ensure converter normal work in discontinuous current mode; When forward voltage is up to +100V, the thyristor will be re-triggered automatically in triggering interval, which ensures thyristor and system safe working; if discontinuous current happens, the thyristor will cut off because of over zero current, at that time thyristor is not in triggering interval yet; to protect thyristor from over voltage, the voltage triggering interval is set up; in this interval if test voltage peak is greater than discontinuous current setting value, the thyristor will be re-triggered.

2. A novel protection method of direct current converter valve thyristor in discontinuous current mode according to claim 1, wherein thyristor electron plate TE realizes automatic re-trigger function by electronic circuit; said electronic circuit is that thyristor voltage Uth links with a 99 k resistor and a 1 k resistor in series to form a voltage divider circuit, and the voltage is assigned in 1:100 proportion; the compared threshold voltage is afford by voltage divider circuit 4 k resistor and 1 k resistor in series, and the threshold voltage is 1V; when thyristor voltage Uth is greater than 100V, comparison circuit will output higher level, and then carry on logic “and” operation with triggering interval; in triggering interval and the thyristor voltage is greater 100V, the re-trigger pulse will be output, and trigger the thyristor to protect the thyristor.

3. A novel protection method of direct current converter valve thyristor in discontinuous current mode according to claim 1, wherein said trigger interval is designed according to signal triggered by the upper valve base electronics VBE which can build the thyristor triggering interval; valve base electronics VBE send double and single pulse to TE, time between double and single pulse is the width of triggering interval, beginning from double pulse complete to the single pulse complete.

4. A novel protection method of direct current converter valve thyristor in discontinuous current mode according to claim 1, wherein said discontinuous current protection value can be set according to the practice operational project and thyristor, change the resistors partial voltage ratio in the test circuit, which can change the threshold of the comparison circuit to change the discontinuous current protection value.
